(19) United States
(12) Patent Application Publication
(10) Pub. No.: US 2005/0035659 A1
(43) Pub. Date: Feb. 17, 2005

(54) Electronic key for an electrical apparatus and electrical apparatus with receiver for an enabling signal

(76) Inventors: Dietmar Hahn, Gerlingen (DE); Roland Walter, Tiefenbronn (DE)

Correspondence Address: STRIKER, STRIKER & STENBY, 103 East Neck Road, Huntington, NY, 11743, US

(21) Appl. No.: 10/886,339

(22) Filed: Jul. 7, 2004

(30) Foreign Application Priority Data
Jul. 31, 2003 (DE) 103 35 017.9

(51) Int. Cl. B60R 25/00

(52) U.S. Cl. 307/10.2

(57) ABSTRACT

The electronic key for disabling or enabling operation of an electrical apparatus, especially for preventing theft of a hand-held power tool, includes a transmitter and antenna for wireless transmission of a release signal to enable operation of the electrical apparatus. For passive current supply the electronic key is provided with a current supply circuit connected electrically with its antenna, in order to obtain electrical energy from an electromagnetic interrogation signal received by its antenna from the electrical apparatus. The electronic key can include a memory for one or more enabling signals for enabling operation of one or more different electrical units. The electrical apparatus includes a receiver with an antenna for receipt of the release or enable signals and a transmitter for the interrogation signal.

### BACKGROUND OF THE INVENTION

1. Field of the Invention

The present invention relates to an electronic key for an electrical apparatus, especially a theft protecting device for a hand-held electrical power tool, which comprises an antenna and transmitter for wireless transmission of a release, enable or unlock signal to the electrical apparatus. It also relates to an electrical apparatus, especially a hand-held electrical power tool, which comprises an antenna and a controller with a receiver for the release, unlock or enable signal.

2. Description of the Related Art

Portable hand-held power tools, for example hand-held power drills and power saws, are frequently operated in locations, where there is a great danger of theft, for example in public buildings, which are accessible to many people. Suitable protection of this sort of hand-held power tool appears to be desirable in view of this theft danger and the accompanying potential legal liabilities resulting from unauthorized use of such equipment.

Furthermore on private property there is a danger of unauthorized use of the hand-held power tools by inexperienced persons, for example children, which can lead to serious injuries. This is of special importance with potentially dangerous units, for example, grinders or hand-held circular saws, which exert a kick or jerk when they are turned on, which can cause the user to inadvertently drop the hand-held power tool. A hand-held electrical power tool equipped with a code device is known from EP 0 674 973 A1. A release or enable code must be entered into the code device, in order to be able to operate the machine. The release or enable code can be input to the hand-held power tool by means of a keyboard or can be read from a code card by means of a code-card reader in the hand-held power tool. Use of the hand-held electrical power tool by authorized personnel is thus possible independently of the type of coding and is otherwise blocked.

Furthermore a hand-held electrical power tool is known from WO 96/06479, which receives a release or enabling signal transmitted by a transmitter by means of a receiver in it. The transmitter of the enabling signal can be mounted locally fixed at a construction site so that the hand-held power tool can be used only at the construction site. In the event that a thief removes the portable hand-held power tool from the construction site, it is no longer within range of the transmitter so that the use of the hand-held power tool is automatically prevented.

### SUMMARY OF THE INVENTION

It is an object of the invention to provide an electronic key for locking and unlocking or releasing an electrical apparatus, especially a hand-held power tool, so that it can be operated, wherein electrical current is supplied to the electronic key passively by an interrogation signal transmitted from the monitored electrical apparatus, so that the electronic key according to the invention requires no current supply of its own in the form of a rechargeable battery or other battery.

It is also an object of the present invention to provide the electrical apparatus, especially a hand-held power tool, including means for transmitting an interrogation signal to the electronic key for unlocking or releasing it to supply current passively to the electronic key.

This object and others, which will be made more apparent hereinafter, is attained in an electronic key for locking or disabling and for releasing or enabling operation of an electrical apparatus, especially a hand-held power tool, in order to protect the electrical apparatus from theft or unauthorized use, which comprises an antenna and a transmitter for wireless transmission of a release or enable signal to the electrical apparatus.

According to the invention the electronic key comprises a current supply circuit for passive current supply, which is connected with its antenna, in order to acquire or collect electrical energy from an electromagnetic interrogation signal received by its antenna.

The current supply circuit, which obtains the energy required for operation of the electronic key, is first activated on receipt of a prompt signal from the supervised electrical apparatus.

Subsequently a transmitter in the electronic key can transmit a release or unlock signal to the electrical apparatus under supervision.

The release or enable signal to be transmitted is preferably stored in a memory in the electronic key. The release or enable signal in the memory can be over-written in preferred embodiments of the electronic key, in order to be able to change the stored release signal for use with other electrical apparatus. The programming of the release signal stored in the electronic key can, for example, take place in a wireless manner by the supervised electrical apparatus or by a separate programming unit. Alternatively it is possible to input the release signal by hand into the electronic key. For this purpose the electronic key according to the invention can have keys or multi-position coding switches.

Furthermore other embodiments are possible in which the memory in the electronic key has a plurality of storage locations for storing different release signals for different electrical apparatus. Each storage location can receive an enable or release signal, which is associated with a certain electrical apparatus and makes its unlocking or release possible. For example, release signals for all the power tools at a certain construction site can be stored in the electronic key of a construction worker at the construction site, so that the construction worker can use all the power tools at the construction site.

The interrogation signal and the release signal preferably can be radio signals. However all types of wireless signals, which permit a wireless current supply of the electronic key, can be used with the electrical apparatus and electronic key according to the invention.

The present invention includes a suitable electrical apparatus, especially in the form of a hand-held electrical power tool, as well as the above-described electronic key.

The electrical apparatus according to the invention has a transmitter for operation together with the above-described electronic key according to the invention. This transmitter transmits the interrogation signal to the electronic key in a wireless manner, in order to prompt the electronic key and provide the electronic key with electrical energy from the interrogation signal.

Preferably the electrical apparatus according to the invention has an optical signal transmitter and/or an acoustic signal transmitter for signaling a release to the user, so that the user knows that the electrical apparatus is released for operation or locked. This optical signal transmitter can be a light-emitting diode or a signal light. The acoustic signal transmitter can be a simple loud speaker or a buzzer, which generates an advisory signal shortly after receipt of the release or enable signal.

Furthermore the electrical apparatus according to the invention preferably has a memory for storing a reference signal with which release signals received from the electronic key are compared. The electrical apparatus is thus not always unlocked or enabled on receipt of a release signal, but only when the received release signal fits or corresponds to a stored reference. In this way several is electrical apparatus can react selectively to an electronic key.

In a preferred embodiment of the invention this memory has several memory locations in order to store reference signals for different electronic keys. For example, each construction worker at the construction site has a respective electronic key, so that each electronic key of the construction worker transmits respective different release signals but can nevertheless activate all electrical units at the construction site.

In a preferred embodiment of the electrical apparatus the electrical apparatus according to the invention can have means for enabling use or unlocking it only for a predetermined time interval after receipt of a release signal by the electrical apparatus. Thus in preferred embodiments of the invention the electrical apparatus includes a clock in order to enable or release the electrical apparatus for use during a predetermined time interval after receipt of the release signal.

However it is also possible that the electrical apparatus is released only until the current supply is interrupted, after receipt of a release or enable signal.

Finally the present invention also includes a complete security system with at least one electronic key and at least one appropriately equipped electrical apparatus.

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is a block diagram of a hand-held electrical power tool according to the invention; and

FIG. 2 is a block diagram of an electronic key according to the invention for enabling and disabling operation of the hand-held power tool shown in FIG. 1.

### DETAILED DESCRIPTION OF THE INVENTION

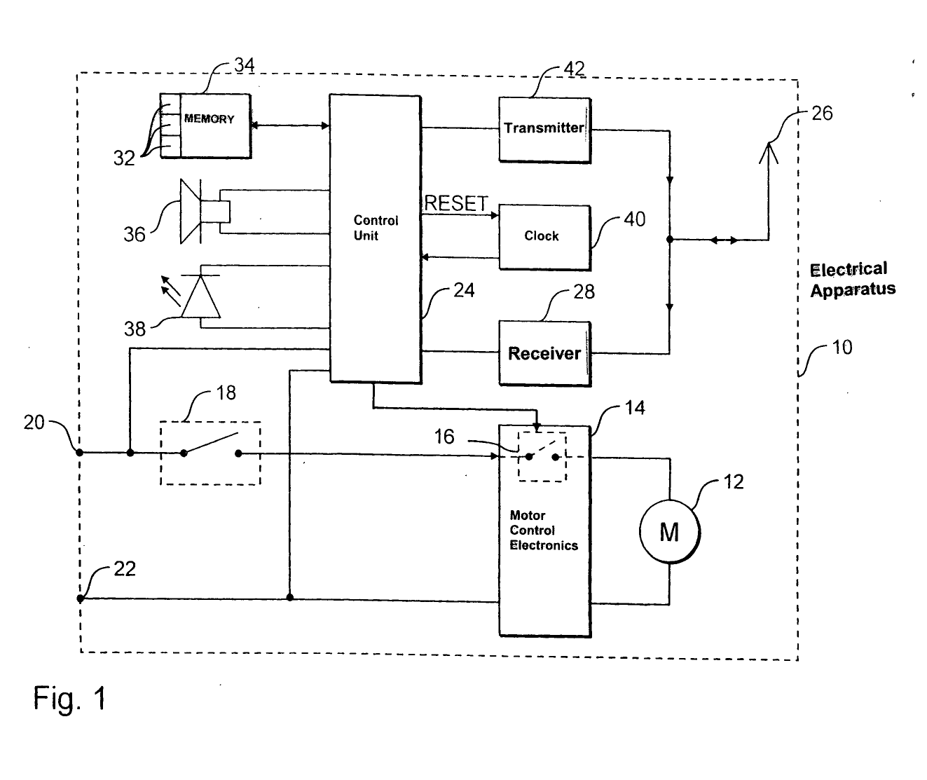

A simplified block diagram of a hand-held electrical power tool 10 according to the invention is shown in FIG. 1 in a simplified form. The hand-held power tool 10 in FIG. 1 is a circular power saw.

The hand-held electrical power tool 10 is driven by an electric motor 12, which is connected with control electronics 14. The control electronics 14 controls operation of the motor 12 and its motor voltage, according to the mechanical load on the electric motor 12, which is known in itself.

The control electronics 14 are connected with two terminals 20,22 by means two voltage-side switches 16, 18. The terminals 20,22 are connected to an electrical power supply.

The switch 18 is the main power switch for the hand-held electrical power tool 10 and can be operated manually by a user of the hand-held power tool in the conventional manner.

In contrast the switch 16 is a controllable switch, which is integrated in the control electronics 14, and comprises a semiconductor switch (Triac, MOSFET, etc.), which is controlled by a control unit 24, in order to enable or disable operation of the hand-held power tool 10. Alternatively the switch 16 comprises a relay.

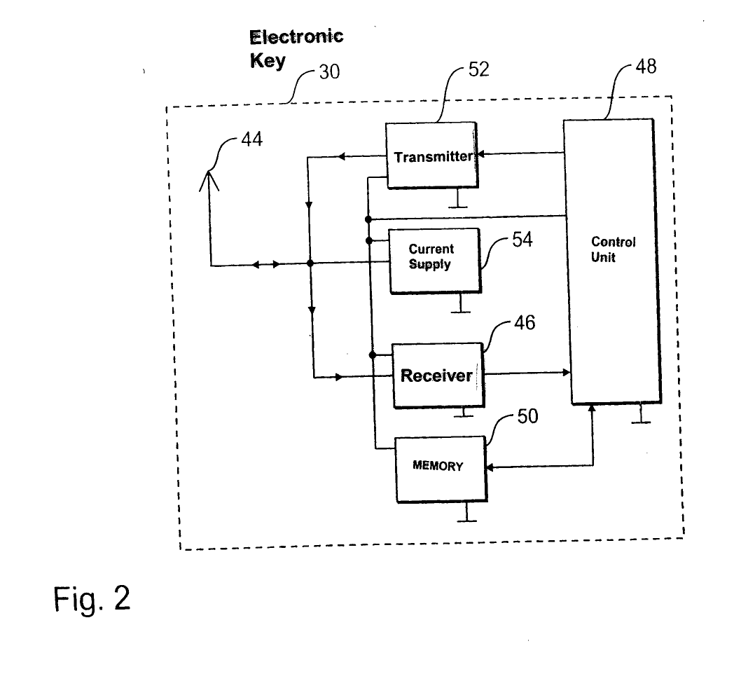

The enabling or disabling of operation of the hand-held power tool 10 occurs according to a release signal, which is received from the electronic key 30 by a receiver 28 with an antenna 26. The electronic key 30 is shown in detail in FIG. 2 and described further hereinbelow.

The control unit 24 tests whether the received release or enable signal authorizes the operator of the electronic key 30 to use the hand-held power tool 10 when a release or enable signal is received from the electronic key by means of the antenna 26 and the receiver 28. For this purpose the control unit 24 compares the received enable or release signal with a plurality of different signals, which are stored in several memory locations 32 of a memory 34. In the event that the received enable or release signal corresponds to one of the reference signals stored in the memory locations 32, the control unit 24 puts the switch 16 in its conducting state, so that the user can start the hand-held power tool 10 by operation of the switch 18.

When the power tool 10 is released the control unit 24 shortly after that also activates a loud speaker 36, which generates a brief advisory signal so that the operator of the power tool 10 is informed of its release for operation.

Also the control unit 24 activates a light emitting diode 38 while the hand-held electrical power tool 10 is enabled for operation, so that the user also has a visual signal indicating release of the power tool 10 so that it can be operated by manually operating the switch 18. Blinking of the light-emitting diode 38 can be used to signal non-recognition or non-detection of the release signal or the release code. The loud speaker 36 and the light emitting diode 38 could also be provided alternatively in various embodiments.

When a release signal is received and subsequently the hand-held power tool 10 is enabled or released for operation, in various alternative embodiments the control unit 24 sets a clock 40, which feeds a trigger signal to the control unit 24 after expiration of a predetermined release time interval. When the control unit 24 receives the trigger signal the switch 16 is put in a non-conducting state so that the release of the hand-held power tool 10 is ended, i.e. the hand-held power tool 10 is disabled.

Moreover release of the hand-held power tool 10 is ended when the current supply from the terminals 20,22 is interrupted or turned off. The control unit 24 is directly connected with the voltage-side terminal 20 for detection of the shut off of the current supply for the power tool 10.

Finally the hand-held electrical power tool 10 has a transmitter 42, which transmits an interrogation signal via antenna 26 to the electronic key 30 when the switch 18 is operated, in so far as the hand-held power tool 10 is not already released or enabled at this time point.

The interrogation signal transmitted from the hand-held power tool 10 serves, among other things, for current supply of the electronic key 30 shown in FIG. 2, which is subsequently described.

The electronic key 30 has an antenna 44 for receipt of the interrogation signal from the hand-held power tool 10, which is connected with a receiver 46. The receiver 46 in the electronic key 30 is connected again with a control unit 48.

On receiving the interrogation signal from the hand-held electrical power tool 10 the control unit 48 reads out a stored release or enable signal from the memory 50 and transmits it by means of the transmitter 52 and antenna 44. The hand-held power tool 10 tests the transmitted release signal in the already described manner.

Furthermore the electronic key 30 according to the invention has a current supply circuit 54. The current supply circuit 54 is similarly connected with the antenna 44 and obtains electrical energy required for operation of the electronic key 30 from the interrogation signal on receipt of the interrogation signal from the hand-held power tool 10. The current supply circuit 54 is thus connected for current supply with the receiver 46, the memory 50, the control unit 48 and the transmitter 52.

The release or enable signal stored in the memory 50 can be programmed in a wireless manner in order to release or unlock other hand-held power tools 10 for operation by a user.

The present invention should not be considered to be limited to the details of the particular embodiments described herein. Many variations and changes of these embodiments are possible without departing from the scope and spirit of the invention claimed hereinbelow.

The disclosure in German Patent Application 103 35 017.9 of Jul. 31, 2003 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in an electronic key for an electrical unit and electrical unit controlled therewith, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

1. An electronic key for locking and for releasing operation of an electrical apparatus, in order to protect the electrical apparatus from theft or unauthorized use, said electronic key comprising
an antenna and a transmitter for wireless transmission of a release signal to the electrical apparatus; and
a current supply circuit for passive current supply, said current supply circuit being connected with said antenna, in order to acquire or collect electrical energy from an electromagnetic interrogation signal received by said antenna.

2. The electronic key as defined in claim 1, further comprising a receiver for receipt of said interrogation signal from said electrical apparatus and wherein said receiver is connected with said antenna.

3. The electronic key as defined in claim 1, further comprising a memory for storing said release signal.

4. The electronic key as defined in claim 3, wherein said memory is over-writable so that a stored release signal can be changed so that operation of another different electrical apparatus may be enabled.

5. The electronic key as defined in claim 3, wherein said memory has a plurality of memory locations for different enable signals for several different electrical units.

6. The electronic key as defined in claim 1, wherein said transmitter is a radio transmitter.

7. The electric key as defined in claim 1, wherein said electrical apparatus is a hand-held electrical power tool.

8. An electrical apparatus comprising
an antenna and a receiver for receipt of a release signal from an electronic key;
a control unit for release or blocking operation in accordance with said release signal, said control unit being connected with said receiver; and
a transmitter for wireless transmission of an electromagnetic interrogation signal to the electronic key in order to supply the electronic key with energy from the interrogation signal and to prompt the release signal from the electronic key.

9. The electrical apparatus as defined in claim 8, further comprising an optical and/or acoustic signaling means for signaling release or unlocking of the electrical apparatus for operation.

10. The electrical apparatus as defined in claim 8, further comprising a memory for storing a reference signal for comparison with said release signal received from the electronic key.

11. The electrical apparatus as defined in claim 10, wherein said memory includes a plurality of memory locations, in order to store additional reference signals for additional electronic keys.

12. The electrical apparatus as defined in claim 8, further comprising a clock for enabling operation only during a predetermined time interval after receipt of the release signal.

13. The electrical apparatus as defined in claim 8, wherein said control unit includes means for disabling the electrical apparatus when a current supply of said electrical apparatus is shut off.

14. The electrical apparatus as defined in claim 8, consisting of a hand-held electrical power tool.

15. A security system comprising at least one electronic key and at least one electrical apparatus supervised by said at least one electronic key;
wherein said at least one electronic key comprises a key antenna and a key transmitter for wireless transmission of a release signal for enabling operation of said at least one electrical apparatus and a current supply circuit for passive current supply, said current supply circuit being connected with said key antenna in order to acquire or collect electrical energy from an electromagnetic interrogation signal received by said key antenna; and
wherein said at least one electrical apparatus comprises an electrical apparatus antenna and an electrical apparatus receiver for receipt of said release signal from said at least one electronic key; a controller for releasing or blocking operation of said at least one electrical apparatus in accordance with said release signal, said controller being connected with said electrical apparatus receiver; and an electrical apparatus transmitter for wireless transmission of the electromagnetic interrogation signal to said at least one electronic key, in order to supply said at least one the electronic key with electrical energy from the interrogation signal and to prompt transmission of the release signal from said at least one electronic key.

16. The security system as defined in claim 15, wherein said at least one electronic key includes a key memory for a plurality of enable signals for enabling operation of said at least one electrical apparatus

17. The security system as defined in claim 15, wherein said at least one electronic key includes a key receiver for receipt of said interrogation signal from said at least one electrical apparatus and wherein said key receiver is connected with said key antenna.

18. The security system as defined in claim 15, wherein said at least one electrical apparatus has an electrical apparatus memory for a plurality of reference signals for comparison with said release signal.

19. The security system as defined in claim 15, wherein said at least one electrical apparatus includes an optical and/or acoustic signaling means for signaling release or unlocking of the electrical apparatus for operation.

20. The security system as defined in claim 15, wherein said at least one electrical apparatus includes a clock for enabling operation only during a predetermined time interval after receipt of the release signal.

21. The security system as defined in claim 15, wherein said at least one electrical apparatus includes means for disabling or locking said at least one electrical apparatus when a current supply of said electrical apparatus is cut off.
